(19) United States
(12) Patent Application Publication
(10) Pub. No.: US 2014/0027259 A1
(43) Pub. Date: Jan. 30, 2014

(54) KEY INPUT DEVICE

(71) Applicant: ALPS ELECTRIC CO., LTD., Tokyo (JP)

(72) Inventors: Yuzura Kawana, Miyagi-Ken (JP); Takashi Sasaki, Miyagi-Ken (JP); Wataru Sato, Miyagi-Ken (JP); Junichi Kurechi, Miyagi-Ken (JP)

(21) Appl. No.: 13/947,551

(22) Filed: Jul. 22, 2013

(30) Foreign Application Priority Data
Jul. 26, 2012 (JP) 2012-165457

(51) Int. Cl. H01H 13/14

(52) U.S. Cl. CPC H01H 13/14
USPC 200/517

(57) ABSTRACT

A tip of a pair of arm portions that integrally extends from a fixed portion and both side portions of a front portion side of a key top are connected with each other in a coupling portion. When a downward pressing force is applied to a center of an operation surface of the key top, a bending moment using a connection portion of a substrate side as a fulcrum and a bending moment using the coupling portion of a tip side as a fulcrum act on the arm portion. The arm portion is deformed into a S-shape having bending deformation portions, and therefore the key top may be lowered in a nearly horizontal posture. The key top has a structure in which both side portions thereof are supported by the arm portions, thereby ensuring a small size and a large elevating stroke.

### CLAIM OF PRIORITY

This application claims benefit of Japanese Patent Application No. 2012-165457 filed on Jul. 26, 2012, which is hereby incorporated by reference in its entirety.

### BACKGROUND

1. Field of the Disclosure

The present disclosure relates to a key input device that inputs an electrical signal by pressing a plurality of key tops or a single key top.

2. Description of the Related Art

Japanese Unexamined Patent Application Publication No. 10-269893 discloses a key input device. In this key input device, a membrane switch sheet having plural groups of electric contacts and a click rubber are overlapped with each other, and a protrusion portion for operating each of the electrical contacts is formed in the click rubber.

A key-top molded body is disposed on the click rubber. A frame portion is provided in the key-top molded body. In the frame portion, a rectangular opening is regularly arranged at a plurality of places, and a rectangular key top is disposed on an inner side of each of the openings. A pair of hinge portions integrally extends from one inner edge of the opening, and the key top is cantilevered by the pair of hinge portions.

When the key top is pressed, the hinge portion is bent and deformed, and the protrusion portion of the click rubber is deformed so as to be crushed by a lower surface of the key top, and therefore the electric contact is switched.

Japanese Unexamined Patent Application Publication No. 9-7446 discloses a switch operating device. In this switch operating device, a switch is provided on a substrate, and a push button is elastically supported by a casing. A plate-like elastic member is supported by an inner surface of the casing. In the plate-like elastic member, an integrated arm portion extends from a fixed end, which is fixed to the casing, so that a pair of arm portions is connected to a free end. An extension portion extending from the free end to the fixed end is integrally formed, so that the push button is supported at a tip of the extension portion. When the push button is pressed, the arm portion of the plate-like elastic member is bent, and at the same time the extension portion is bent and deformed, so that the switch is pressed.

In the switch operating device, the push button may easily maintain a horizontal posture by bending of both the arm portion of the plate-like elastic member and the extension portion.

In the key input device described in Japanese Unexamined Patent Application Publication No. 10-269893, the pair of hinge portions extending from the inner edge of the opening formed in the frame portion is connected to an edge portion facing an inner edge of the key top. Therefore, a free length of the hinge portion is significantly reduced, so that it is difficult to set a reaction force when pressing the key top, and the strength of the hinge portion is decreased.

In addition, since the key top is deformed only in a direction in which an edge portion of the free end located away from the inner edge is lowered, it is difficult to sufficiently push the protrusion portion of the click rubber by the key top. Also, when the key top is pressed in the vicinity of a coupling portion coupled with the hinge portion, it is impossible to lower the key top at a sufficient stroke, and it is further difficult to sufficiently push the protrusion portion.

The switch operating device described in Japanese Unexamined Patent Application Publication No. 9-7446 has a structure in which the extension portion extends from the free end of the plate-like elastic member toward a base end portion thereof and the push button corresponds to the distal end of the extension portion, and therefore the plate-like elastic member has a long dimension reaching from a contact portion with the push button to the free end. As a result, it is difficult to densely dispose a plurality of push buttons using a plurality of plate-like elastic members.

### SUMMARY

A key input device has an input unit disposed on a substrate and a key top for pressing the input unit. Here, a fixed portion fixed to the substrate, a pair of arm portions that are elastically deformable, and the key top supported at the arm portion may be integrally formed, the pair of arm portions may extend along two side portions of the key top facing each other continuously with the fixed portion, a continuing coupling portion may be provided in a direction crossing an extending direction of the arm portion on a top of the arm portion, and at least a part of the coupling portion is connected to a side portion of a front side separated from the fixed portion of the key top.

### BRIEF DESCRIPTION OF THE DRAWINGS

FIG. 1 is a plan view showing an embodiment of a key input device according to an embodiment of the present invention used as a keyboard device;

FIG. 2 is a partial exploded perspective view showing a part of the key input device shown in FIG. 1 in a vertically inversed direction;

FIG. 3 is a partial exploded perspective view showing a part of a key input device in a vertically normal direction;

FIG. 4A is a plan view showing a part of a key unit provided in a key input device from above, and FIG. 4B is a cross-sectional view thereof;

FIG. 5A is a cross-sectional view taken along a V-V line of FIG. 1 while showing a state in which the key unit shown in FIG. 4 is mounted to a key board device, and FIG. 5B is an enlarged cross-sectional view showing a structure of an input unit;

FIG. 6 is a cross-sectional view taken along a VI-VI line of FIG. 1 while showing a state in which the key unit shown in FIG. 4 is mounted to a keyboard device;

FIG. 7A is an operational explanation view when a substantially center of a key top is pressed, and FIG. 7B is a side view of an arm portion of the key unit when a downward force is applied to the key unit;

FIGS. 8A and 8B are an operational explanation view when a front portion of a key top is pressed;

FIGS. 9A and 9B are an operational explanation view when a rear portion of a key top is pressed;

FIG. 10 is an operational explanation view when a side portion of a key top is pressed;

FIG. 11 is a cross-sectional view obtained when a key unit provided in a key input device according to a second embodiment of the present invention is viewed in the same direction as FIG. 5;

FIG. 12 is a cross-sectional view obtained when a key unit provided in a key input device according to a third embodiment of the present invention is viewed in the same direction as FIG. 6;

FIG. 13 is a plan view of a key unit provided in a key input device according to a fourth embodiment of the present invention; and

FIG. 14A is an explanation view of an embodiment of the key top of the present invention and FIG. 14b is an explanation view a comparative example of a key top.

### DESCRIPTION OF THE EXEMPLARY EMBODIMENTS

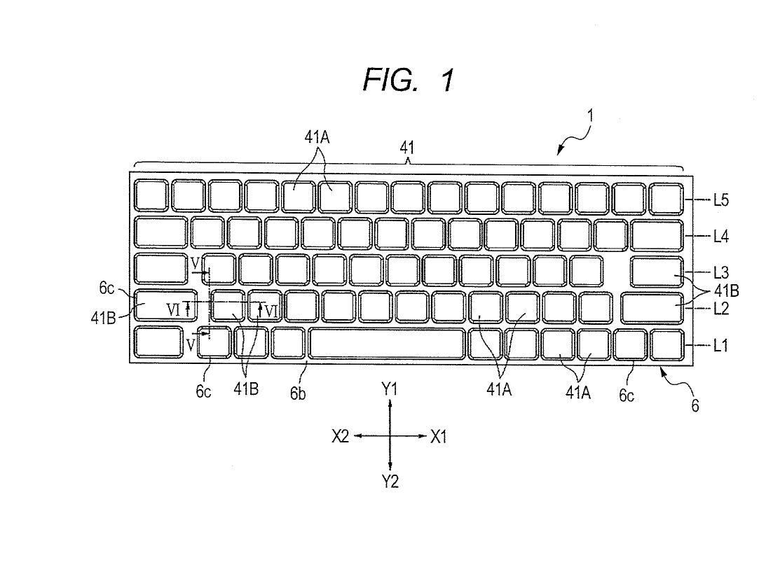

A key input device 1 shown as a plan view of FIG. 1 is a small and thin keyboard device, and is used being connected to a portable communication device using a USB interface.

In each drawing, a Z1 direction is an upward direction (upper side), a Z2 direction is a downward direction (lower side), a Y1 direction is a forward direction (front side and tip side), a Y2 direction is a backward direction (rear side and substrate side), a X1 direction is a rightward direction, and a X2 direction is a leftward direction.

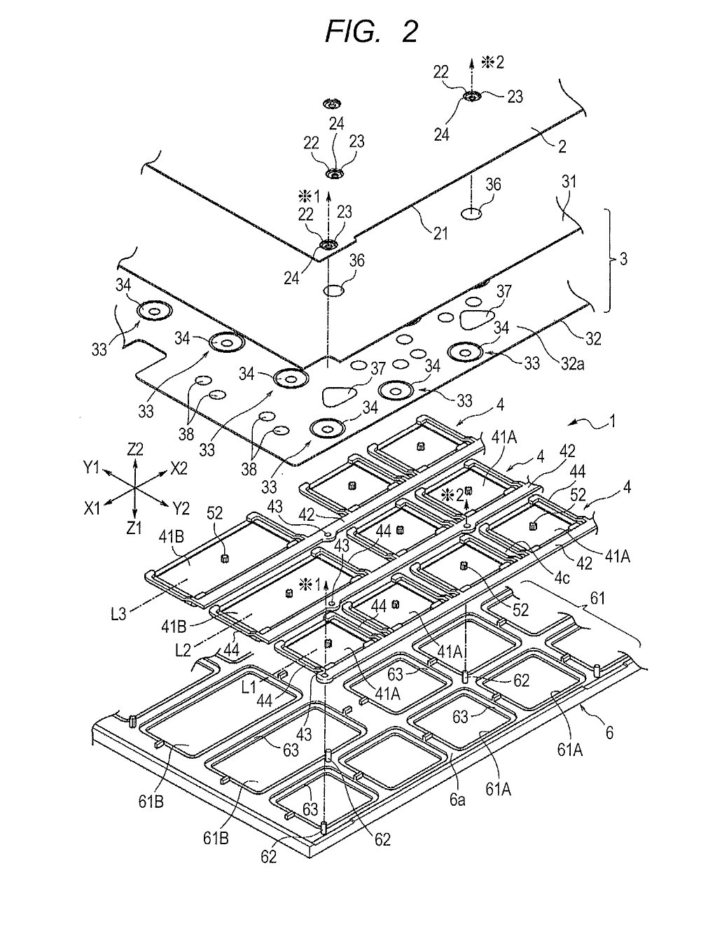

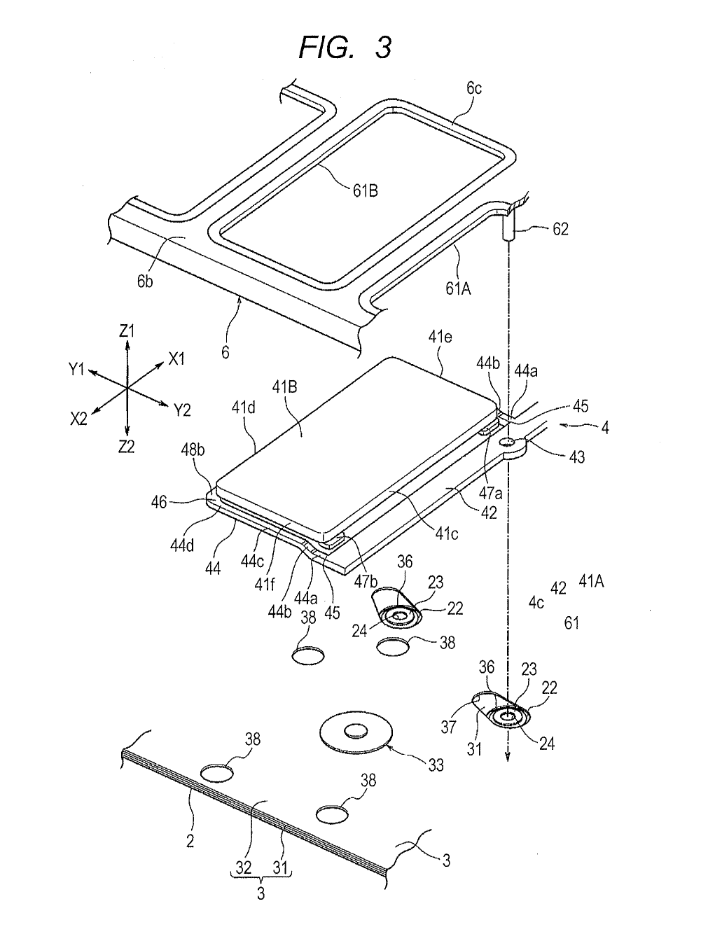

In FIG. 2, the key input device 1 is shown in a vertically inversed direction, and in FIG. 3, the key input device 2 is shown in a vertically normal direction. As shown in FIGS. 2 and 3, in the key input device 1, a substrate 2 is provided at the bottom (Z2 side), and a sheet laminated body 3 is disposed on the substrate 2. A plurality of key units 4 are disposed on the sheet laminated body 3, and the top (Z1 side) is covered with a cover 6.

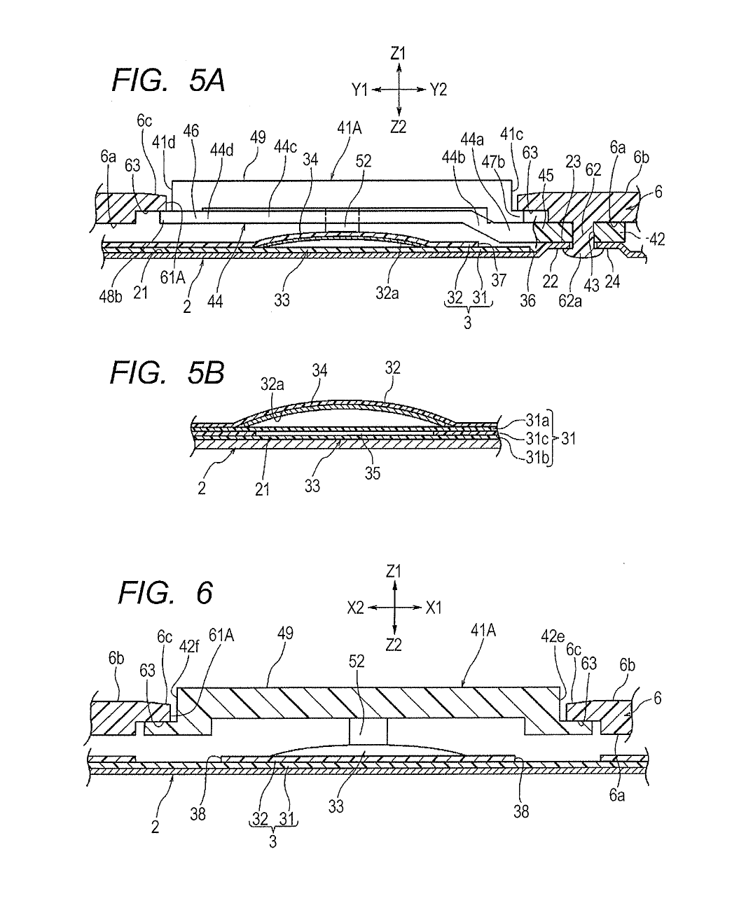

The substrate 2 positioned on the Z2 side that is the bottom is formed of a metal plate. As shown in FIGS. 2 and 5, in the substrate 2, a surface facing upward (Z1 side) is a support plane 21, and swelling portions 22 swelling upward (Z1 direction) are formed at a plurality of places of the support plane 21 by a drawing method. As shown in FIGS. 3 and 5, an apex of each of the swelling portions 22 is a support portion 23 having a nearly planar shape, and a positioning fixed hole 24 is opened at a center of the support portion 23.

As shown in FIGS. 2 and 5A, the sheet laminated body 3 is composed in such a manner that a spring member holding sheet 32 is superimposed on a membrane switch laminated body 31. As shown in FIG. 5B in detail, the membrane switch laminated body 31 is a contact forming sheet, and is composed in such a manner that an upper flexible sheet 31a, a lower flexible sheet 31b, a spacer sheet 31c positioned between both flexible sheets 31a and 31b are stacked. These sheets 31a, 31b, and 31c are all electrical insulating sheets.

Input units 33 are provided at a plurality of places of the sheet laminated body 3. As shown in FIG. 5B, in each of the input units 33, an opening is formed in the spacer sheet 31c of the membrane switch laminated body 31, and an operation space 35 in which the upper flexible sheet 31a and the lower flexible sheet 31b vertically face each other is formed. In the operation space 35, an upper contact portion is provided on a lower surface of the upper flexible sheet 31a and a lower contact portion is provided on an upper surface of the lower flexible sheet 31b. On the lower surface of the upper flexible sheet 31a and the upper surface of the lower flexible sheet 31b, a conductive lead layer in continuity with each of the contact portions is provided.

In each of the input units 33, a spring member 34 is mounted on a surface 32a facing a lower side (Z2 side) of the spring member holding sheet 32 to be held. The spring member 34 is a plate spring formed of a springy metallic plate, and is formed in a so-called dome shape. As shown in FIG. 5B, in each of the input units 33, the spring member 35 is provided so as to face above the operation space 35 of the membrane switch laminated body 31.

In the input unit 33, when the spring member holding sheet 32 is pressed, the spring member 34 is inversely operated downward, the upper flexible sheet 31a is pressed by the spring member 34, and the operation space 35 is vertically compressed, so that the continuity between the lower contact portion and the upper contact portion is stabilized.

As shown in FIGS. 2 and 3, a round relief hole 36 is formed in the membrane switch laminated body 31, and a triangular relief hole 37 is formed in the spring member holding sheet 32. As shown in FIGS. 3 and 5A, when the sheet laminated body 3 is provided on the support plane 21 of the substrate 2, the swelling portion 22 formed in the substrate 2 is positioned within the relief holes 36 and 37, and the support portion 23 of the apex of the swelling portion 22 protrudes upward from the membrane switch laminated body 31.

As shown in FIG. 1, the key input device 1 has a plurality of key tops 41. The plurality of key tops 41 are arranged in parallel along the right and left direction (X1-X2 direction) in rows L1, L2, L3, L4, and L5. As shown in FIG. 2, the key top 41 of each row is supported by a common fixed portion 42, and the key unit 4 is composed for each row. In the key unit 4, all key tops 41 of one row may be supported by the common fixed portion 42, and the fixed portion 42 may be divided within the same row so that the key unit 4 is divided into two units, three units, or the like within the same row to be arranged.

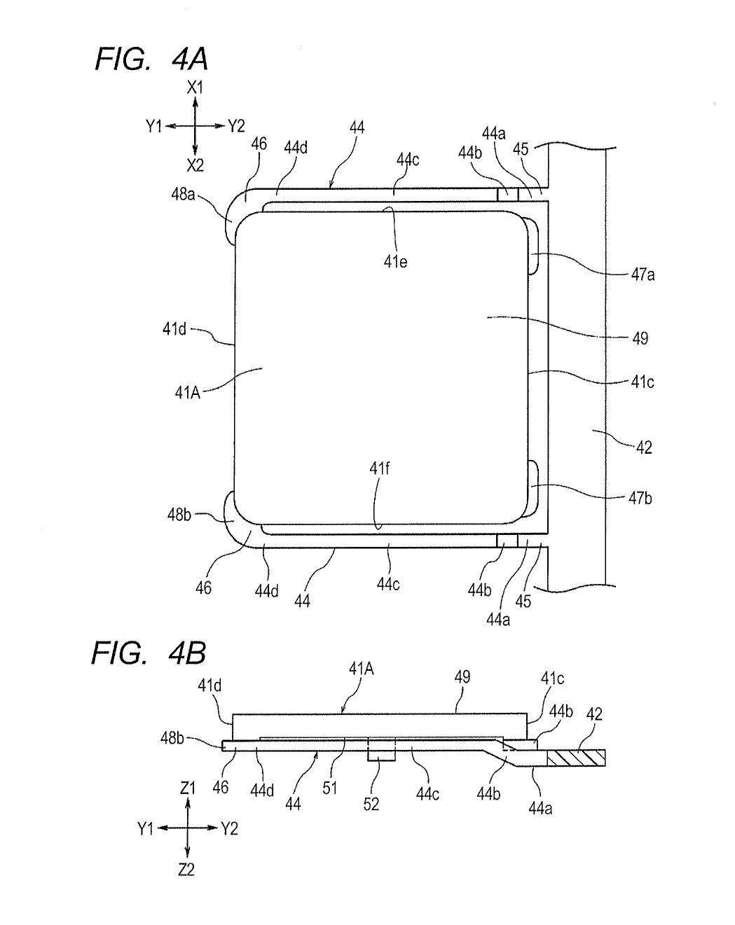

The key top 41 may include key tops having different shapes and sizes. A support structure of a rectangular key top 41B is shown in FIG. 3, and a support structure of a square key top 41A is shown in FIG. 4. However, the support structure of the key top having different shapes and different sizes than the support structure of the rectangular key top 41 B is still substantially the same as those of FIGS. 3 and 4. The cover 6 covering a surface side (Z1 side) of the key input device 1 is made of a synthetic resin material. As shown in FIGS. 2 and 3, a plurality of window portions 61 are regularly arranged and opened in the cover 6. Each of the key tops 41 is disposed inside the window portion 61. The shape and opening area of the window portion 61 are determined corresponding to the shape and size of the key top 41 disposed in the window portion 61. In FIG. 2, the square window portion 61A corresponding to the square key top 41A and the rectangular window portion 61B corresponding to the rectangular key top 41B are shown.

As shown in FIG. 2, in the cover 6, a positioning fixed protrusion 62 extending from a fixed surface 6a that is a lower surface of the cover 6 downward is integrally formed.

Each of the key units 4 is made of a synthetic resin material in its entirety and integrally formed. As shown in FIG. 2, in each of the key units 4, the fixed portion 42 is a fixed rib extending linearly in the X1-X2 direction for each of rows L1, L2, L3, L4, and L5. In each of the fixed portions 42 (fixed rib), a thickness dimension in a vertical direction (Z1-Z2 direction) is constant, and a width dimension in a front and back direction (Y1-Y2 direction) is also almost constant.

As shown in FIG. 2, in the fixed portion 42 formed in each of the key units 4, positioning holes 43 of each of the plurality of places are formed so as to vertically penetrate.

In an assembly operation of the key input device 1, the cover 6 is disposed in a vertically inversed direction as shown in FIG. 2, the key unit 4, the sheet laminated body 3, and the substrate 2 are stacked on the cover 6 in the stated order. In the assembly operation, each of the positioning fixed protrusions 62 provided in the cover 6 is inserted into the positioning hole 43 formed in the fixed portion 42 of the key unit 4. Moreover, the positioning fixed protrusion 62 is inserted into the positioning fixed hole 24 formed in the swelling portion of the substrate 2.

As shown in FIG. 5, a tip 62a of the positioning fixed protrusion 62 is melted on an inner side of the swelling portion 22, and the positioning fixed protrusion 62 is caulked and fixed to an inner side of the support portion 23 of the apex of the swelling portion 22. Thus, the fixed portion 42 of each of the key units 4 is sandwiched and fixed between the support portion 23 of the apex of the swelling portion 22 of the substrate 2 and the fixed surface 6a that is a lower surface of the cover 6.

In FIG. 3, the rectangular key top 41B provided in an end of the X2 side of the key unit 4 disposed in an L2 row is shown, and in FIG. 4, the square key top 41B provided in the same key unit 4 of an L2 row is shown. The rectangular key top 41B includes a rear portion 41c facing the fixed portion 42, a front portion 41d of an opposite side of the rear portion 41c, a right side portion 41f, and a left side portion 41e. In the same manner, the square key top 41A also includes a rear portion 41c, the front portion 41d, a right side portion 41e, and a left side portion 41f. Each of the rear portion 41c and the front portion 41d has a side (side surface) parallel in a right and left direction (X1-X2 direction), and each of the right side portion 41e and the left side portion 41f has a side (side surface) parallel in the front and back direction (Y1-Y2 direction).

As shown in FIGS. 3 and 4, single key top 41A and single key top 41B are respectively supported by a pair of arm portions 44 and 44. The shape and dimension of the arm portion 44 are substantially the same as those of the key top 41A and the key top 41B.

As shown in FIGS. 3 and 4, a base 44a of each of the arm portions 44 integrally extends from the fixed portion (fixed rib) 42 in a connection portion 45, and the pair of arm portions 44 are spaced at a short distance from the right side portion 41e and the left side portion 41f of the key tops 41A and 41B and extend parallel to the right side portion 41e and the left side portion 41f.

As shown in FIGS. 3 and 4B, the base 44a of the arm portion 44 is formed to have the same thickness dimension as the fixed portion 42. A rising portion 44b continues on a tip side rather than the base 44a from the arm portion 44, and a horizontal portion 44c continues ahead thereof. The arm portion 44 is directed upward (Z1 side) in the rising portion 44b, and the horizontal portion 44c is positioned upward (Z1 side) from the base 44a and the connection portion 45. A tip 44d of the arm portion is connected to the key tops 41A and 41B through a coupling portion 46.

The arm portion 44 is elastically deformable at least in the horizontal portion 44c. The horizontal portion 44c of the arm portion 44 is formed in a flat plate shape in which a thickness dimension in a vertical direction (Z1-Z2 direction) is smaller than a width dimension in a right and left direction (X1-X2 direction). The horizontal portion 44c may be capable of bending deformation (deflection deformation) in a state in which a curvature direction faces a front and back direction (Y1-Y2 direction), and may be capable of twisting-deformation of axial rotation parallel to the Y1-Y2 direction. The base 44a and the rising portion 44b may be also elastically deformable in the same manner, but the base 44a and the rising portion 44b may have a thickness dimension which cannot be elastically deformable.

As shown in FIGS. 3 and 4A, the coupling portion 46 continuing from the tip 44d of the arm portion 44 extending along the left side portion 41f of the key tops 41A and 41B continuously extends in the right direction (X1 direction) that is a direction crossing an extending direction (Y1-Y2 direction) of the arm portion 44, and is integrally connected to both the left side portion 41f and the front portion 41d of the key tops 41A and 41B. The coupling portion 46 continuing from the tip 44d of the arm portion 44 extending along the right side portion 41e of the key tops 41A and 41B continuously extends in the left direction (X2 direction) that is a direction crossing the extending direction (Y1-Y2 direction) of the arm portion 44, and is integrally connected to both the right side portion 41e and the front portion 41d of the key tops 41A and 41B.

In the coupling portion 46 that connects the tip 44d of the arm portion 44 and the key tops 41A and 41B, a dimension in a front and back direction (Y1-Y2 direction) and in a right and left direction (X1-X2 direction) is significantly shorter than the whole length of the arm portion 44, and therefore the coupling portion 46 is hardly elastically deformable. However, by increasing the dimension in the right and left direction (X1-X2 direction) of the coupling portion 46, the coupling portion 46 may be capable of twisting-deformation of axial rotation extending in the right and left direction (X1-X2 direction).

As shown in FIGS. 3 and 4, in the key tops 41A and 41B, a pair of back abutting portions 47a and 47b that protrude backward (Y2 direction) from the rear portion 41c are integrally formed. One back abutting portion 47a is provided in a position close to the right side portion 41e, the other back abutting portion 47b is provided in a position close to the left side portion 41f. As shown in FIG. 4B, the back abutting portions 47a and 47b are positioned away downward (Z2 direction) from an operation surface 49 that is an apex of the key tops 41A and 41B.

As shown in FIG. 4A, front abutting portions 48a and 48b are integrally formed in each coupling portion 46 that connects the arm portions 44 and 44 and the key tops 41A and 41B. One front abutting portion 48a is positioned on the right side (X1 side), and the other front abutting portion 48b is positioned in the left side (X2 side).

The front abutting portions 48a and 48b and the coupling portions 46 and 46 are integrally formed, and a boundary of both portions is not clear. In this embodiment, one of the coupling portions 46 and 46 that protrudes frontward (Y1 direction) from the front portion 41d of the key tops 41A and 41B mainly functions as the front abutting portions 48a and 48b. As shown in FIG. 4B, the front abutting portions 48a and 48b are positioned away downward (Z2 direction) from the operation surface 49 that is an apex of the key tops 41A and 41B.

As shown in FIGS. 2 and 4B, on the lower surface 51 of each of the key tops 41A and 41B, a pressing portion 52 that integrally protrudes downward (Z2 direction) from a center thereof is integrally formed.

As shown in FIGS. 2, 5A, and 6, on an inner surface downward (Z2 direction) of the cover 6, a receiving surface 63 is formed around each of the window portions 61A and 61B. The receiving surface 63 is positioned upward (Z1 side) from the fixed surface 6a of the inner surface of the cover 6. The receiving surface 63 is formed over the whole length of the circumference of each of the window portions 61A and 61B.

In the assembly operation of the key input device 1, as shown in FIG. 2, the inner surface of the cover 6 is made facing upward, the plurality of key units 4 are disposed thereon, the sheet laminated body 3 is stacked thereon, and then the substrate 2 is stacked thereon. As shown in FIGS. 3 and 5, the swelling portion 22 integrally formed on the substrate 2 is disposed inside the relief hole 36 of the membrane switch laminated body 31 of the sheet laminated body 3 and the relief hole 37 of the spring member holding sheet 32.

The positioning fixed protrusion 62 integrally formed on the inner surface of the cover 6 is inserted into the positioning hole 43 formed in the fixed portion 42 of the key unit 4, and further inserted into the positioning fixed hole 24 of the swelling portion 22, so that the front portion of the positioning fixed protrusion 62 is melted and then caulked and fixed as shown in FIG. 5. Therefore, the fixed portion 42 of each of the key units 4 is firmly inserted and fixed between the support portion 23 of the apex of the swelling portion 22 and the fixed surface 6a that is the lower surface of the cover 6.

As shown in FIG. 2, in each of the key units 4, the plurality of key tops 41 are supported by the fixed portion 42, and therefore the plurality of key tops 41 may be simultaneously assembled, and the efficiency of the assembly operation may be improved.

Each of the key units 4 has a structure in which the plurality of key tops 41 are supported by the fixed portion (fixed rib) 42 extending in the right and left direction (X1-X2 direction). Since the respective fixed portions 42 are independent from each other, a rib extending in the front and back direction (Y1-Y2 direction) for connecting the fixed portions 42 is not required. The rib extending in the Y direction does not exist between the key tops 41 adjacent to each other in the right and left direction (X1-X2 direction), and therefore a disposition interval of the respective key tops 41 in the right and left direction (X1-X2) may be reduced, and an arrangement area of the large number of the key tops 41 may be reduced.

As shown in FIGS. 5 and 6, when the key input device 1 is assembled, the fixed portion 42 of each of the key units 4 is inserted between the support portion 23 of the apex of the swelling portion 22 and the fixed surface 6a that is the lower surface of the cover 6, and firmly fixed so as to prevent from being easily operated. The key top 41 supported by the fixed portion 42 of each of the key units 4 is disposed inside the window portion 61 that is opened in the cover 6.

As shown in FIGS. 5 and 6, in each of the input units 33, the apex of the swelling portion due to the spring member 34 provided in the sheet laminated body 3 abuts on the lower surface of the pressing portion 52 protruding downward from each of the key tops 41. The back abutting portions 47a and 47b and the front abutting portions 48a and 48b which are provided in the key top 41 abut on the receiving surface 63 formed in the vicinity of the window portion 61 of the cover 6 by an upward elastic force of the spring member 34 and an elastic force of each of the arm portions 44 provided in the key unit 4, and preferably, the back abutting portions 47a and 47b and the front abutting portions 48a and 48b are pressed against the receiving surface 63 with a light elastic force. Therefore, each of the key tops 41 protrudes at a uniform height from the surface 6b of the cover 6.

As shown in FIGS. 3 and 4B, in the arm portion 44 supporting the key top 41, the coupling portion 46 connected to the key top 41 rather than the connection portion 45 connected to the fixed portion 42 is located in a higher position. Thus, when each of the key top 41 is pressed downward (Z2 direction), the arm portion 44 may ensure a vertically large amount of deflection deformation when the tip 44d of the arm portion 44 is displaced downward. As a result, a large movement stroke below the key top 41 may be ensured, and an excellent operation touch when pressing each of the key tops 41 may be obtained.

In addition, since each of the key tops 41 is positioned upward (Z1 side) from the fixed portion 42, the key top 41 is positioned upward even when a vertical thickness dimension reaching from the substrate 2 to the cover 6 is composed to be formed in a thin shape, and therefore a protruding height dimension reaching from the surface 6b of the cover 6 to the operation surface 49 of the key top 41 may be increased.

As shown in FIGS. 3, 5A, and 6, so as to surround the circumference of the window portion 61 formed in the cover 6, an inclined surface 6c gradually descending toward the window portion 61 from the surface 6b is formed, and therefore the amount of protrusion of the key top 41 from the surface 6b is increased, and the key input device 1 whose pressing operation is easily performed even if the device is compact, that is, the key board device may be composed.

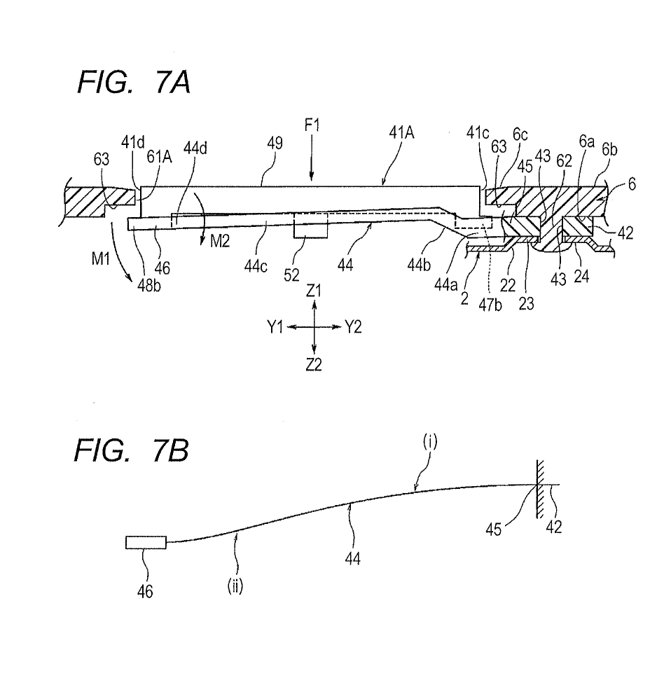

Next, operations of the key input device 1 will be described. In FIGS. 7 and 10, an operation when the square key top 41A is pressed is shown. The operation is the same as in the rectangular key top 41B shown in FIG. 3.

In FIG. 7, an operation when a downward pressing force F1 is given to substantially the center of the operation surface 49 of the key top 41A is shown.

As shown in FIG. 4, the arm portions 44 and 44 that are positioned on both left and right sides of the key top 41A extend from the fixed portion 42 to a position in which the tip 44d of the arm portion 44 approaches the front portion 41d of the key top 41A. Therefore, the arm portions 44 and 44 may ensure a long overall length in the front and back direction (Y1-Y2 direction) capable of bending deformation.

As shown in FIG. 7A, when the pressing force F1 acts on substantially the center of the operation surface 49 of the key top 41A, a downward force acts on the coupling portion 46 for connecting the tip 44d of the arm portion 44 and the key top 41A, and a counterclockwise bending moment M1 using the connection portion 45 and the fixed portion 42 as a fulcrum acts on the arm portion 44. In addition, a counterclockwise bending moment M2 using the coupling portion 46 as a fulcrum is applied to the front portion of the arm portion 44 from the key top 41A.

As shown in FIG. 7B, in the arm portion 44, a predetermined range forward (Y1 direction) from the connection portion 45 connecting with the fixed portion 42 is a bending deformation portion i whose protruding side faces upward (Z1 direction), and a front portion from the predetermined range is a bending deformation portion ii whose protruding side faces downward (Z2 direction).

As shown in FIG. 7B, a substantially S-shaped deflection having the bending deformation portions i and ii occurs in the arm portion 44, and therefore the back abutting portions 47a and 47b of the key top 41A and the front abutting portions 48a and 48b are separated downward together from the receiving surface 63 of the cover 6, and the key top 41A is lowered without being largely inclined while maintaining a nearly horizontal position.

In this instance, elastic deformation hardly occurs in the coupling portion 46 connecting the arm portion 44 and the key top 41A. However, the coupling portion 46 may have a structure in which twisting deformation of axial rotation in the right and left direction (X1-X2 direction).

When the input unit 33 of the sheet laminated body 3 is pressed by the pressing portion 52 of the key top 41A, the spring member 34 is deformed downward and reversed, and therefore a switch input is given. When the pressing force F1 to the key top 41A is released, the spring member 34 restores the shape, and the key top 41A returns to an initial posture shown in FIG. 5 by the biasing force.

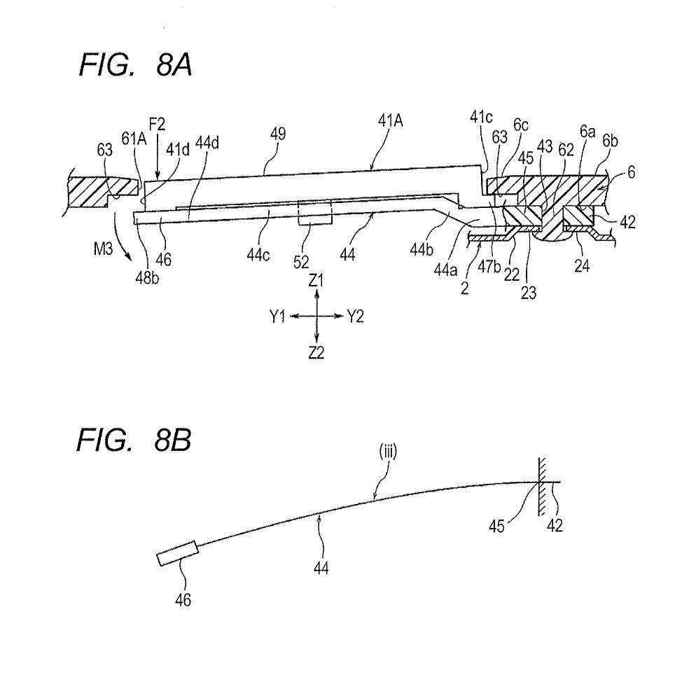

In FIG. 8, an operation when the downward pressing force F2 is applied at a place close to the front portion 41d of the key top 41A is shown.

When the pressing force F2 acts, a counterclockwise bending moment M3 using the connection portion 45 as a fulcrum is applied to the arm portion 44, so that a bending deformation portion iii whose protruding side faces upward (Z1 direction) over nearly the whole length is formed in the arm portion 44 as shown in FIG. 8B. As a result, the key top 41A has an inclined posture in which the key top 41A is rotated in the counterclockwise direction using the abutting portion between the back abutting portions 47a and 47b and the receiving surface 63 of the cover 6 as a fulcrum.

When the input unit 33 of the sheet laminated body 3 is pressed by the pressing portion 52 of the key top 41A, the spring member 34 is deformed downward and reversed, and therefore a switch input is given.

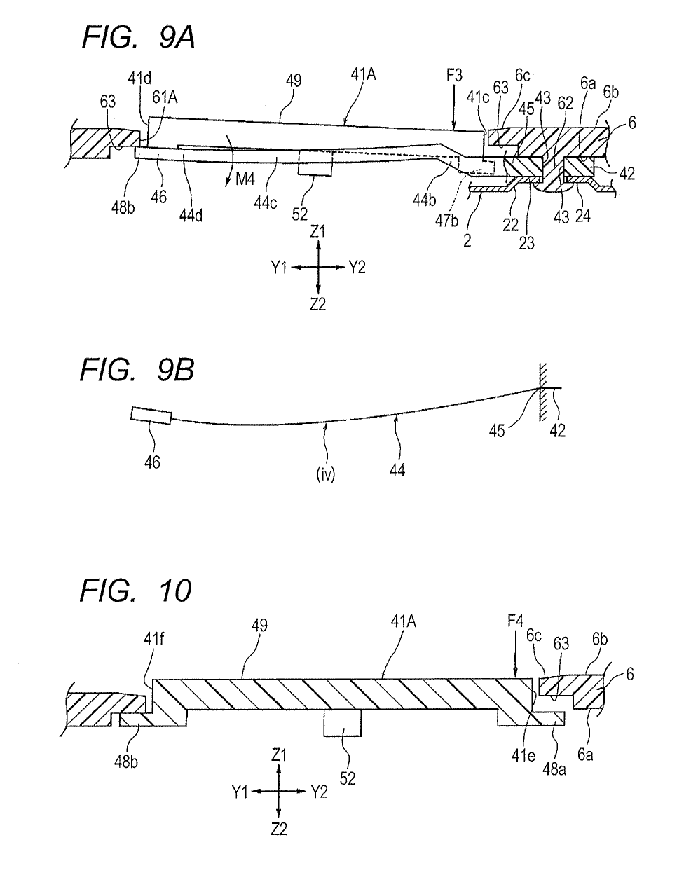

In FIG. 9, an operation when a downward pressing force F3 is applied at a place close to the back portion 41c of the key top 41A is shown.

When the pressing force F3 acts on a position close to the back portion 41c, a counterclockwise bending moment M4 using the coupling portion 46 of the Y1 side as a fulcrum is applied to the arm portion 44 from the key top 41A, so that a bending deformation portion iv whose protruding side faces downward (Z2 direction) over the whole length of the arm portion 44 is formed as shown in FIG. 9B.

As a result, the key top 41A has an inclined posture in which the key top 41A is rotated in the counterclockwise direction using the abutting portion between the front abutting portions 48a and 48b and the receiving surface 63 of the cover 6 as a fulcrum. When the input unit 33 of the sheet laminated body 3 is pressed by the pressing portion 52 of the key top 41A, the spring member 34 is deformed downward and reversed, and therefore a switch input is given.

In FIG. 10, an operation when a downward pressing force F4 is applied to the operation surface 49 of the key top 41A at a place close to the right side portion 41e is shown.

In this instance, bending deformation similar to that in FIG. 7B occurs in the arm portion 44 of the right side extending along the right side portion 41e of the key top 41A, and twisting deformation of axial rotation in the Y1-Y2 direction further occurs. Meanwhile, twisting deformation of axial rotation mainly in the Y1-Y2 direction occurs in the arm portion 44 of the left side extending along the left side portion 41f of the key top 41A.

As a result, the key top 41A has an inclined posture in which the right side portion 41e descends, using the abutting portion between the back abutting portion 47b of the left side and the receiving surface 63 of the cover and the abutting portion between the front abutting portion 48b of the left side and the receiving surface 63 of the cover 6 as a fulcrum. The input unit 33 of the sheet laminated body 3 is pressed by the pressing portion 52 of the key top 41A, and the spring member 34 is deformed downward and reversed, and therefore a switch input is given.

In addition, an operation when the key top 41A is pressed downward at a place close to the left side portion 41f is bilaterally symmetrical with FIG. 10, and the key top 41A has an inclined posture in which the left side portion 41f descends using the abutting portion between the back abutting portion 47a of the right side and the receiving surface 63 of the cover 6 and the abutting portion between the front abutting portion 48a of the right side and the receiving surface 63 of the cover 6 as a fulcrum. Even in this case, the input unit 33 of the sheet laminated body 3 is pressed by the pressing portion 52 of the key top 41A, and the spring member 34 is deformed downward and reversed, and therefore a switch input is given.

As shown in FIGS. 2 and 3, an opening 38 is formed in the spring member holding sheet 32 of the sheet laminated body 3. As shown in FIG. 6, the opening 38 faces below the back abutting portions 47a and 47b and the front abutting portions 48a and 48b of the key top 41A. When the posture is changed as shown in FIGS. 7 and 10 in such a manner that the key top 41A is pressed, at least a part of the back abutting portions 47a and 47b and the front abutting portions 48a and 48b of the key top 41A may be inserted into the opening 38 facing this. Therefore, a descending distance between the back abutting portions 47a and 47b and the front abutting portions 48a and 48b may be increased, and a large descending stroke of the key top 41A may be ensured. As a result, it is possible to operate the input unit 33 by reliably pressing the input unit 33 by the pressing portion 52 of the key top 41A.

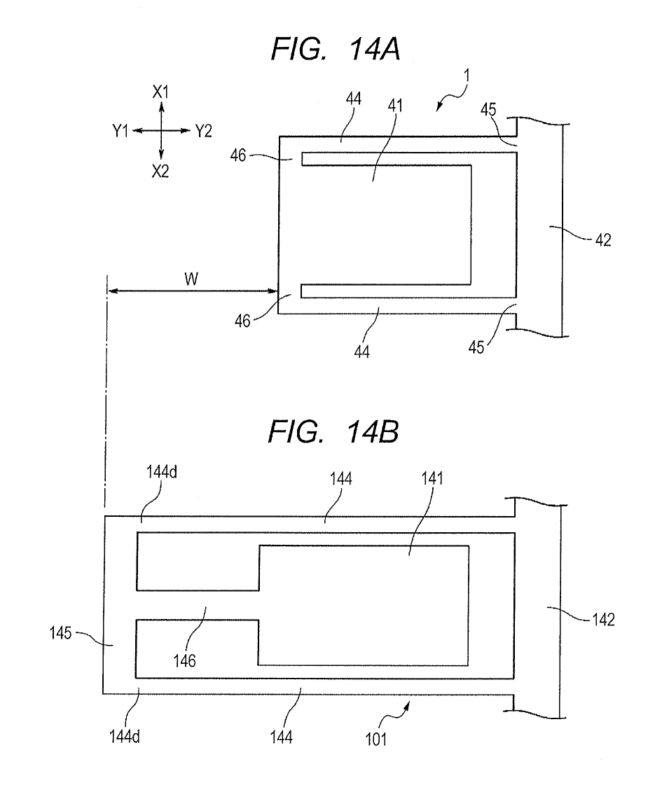

FIG. 14A is a schematic view when a support structure of the key top 41A in the key input device 1 according to an embodiment of the present invention is viewed from the above, and the FIG. 14B is a schematic view when a support structure of a key top 141 in a key input device 101 according to a comparative example is viewed from the above.

In the key input device 101 according to the comparative example, the key top 141 is supported by the same plate-like elastic member as that described in Japanese Unexamined Patent Application Publication No. 9-7446. That is, a pair of arm portions 144 and 144 extend from a fixed portion 142, and front portions 144d and 144d of the pair of arm portions 144 and 144 are connected in a coupling portion 145. A second arm portion 146 extends toward the fixed portion 142 from the coupling portion 145, and the key top 141 is supported by the second arm portion 146.

The key input device 101 according to the comparative example has a structure in which both sides of the arm portion 144 and the second arm portion 146 can be bent and deformed.

However, since the second arm portion 146 is provided in the key input device 101 according to the comparative example, a length in a front and back direction (Y1-Y2 direction) is longer than that of the key input device 1 according to the present invention by a dimension W, and therefore an arrangement density of the key tops 141 may not be increased, and miniaturization of the key input device 101 may be difficult.

On the other hand, in the key input device 1 according to the present invention, the arm portion 44 along the right side portion 41e of the key top 41A and the arm portion 44 along the left side portion 41f are provided, and tip sides of both side portions of the key top 41A are connected to the front portions of the arm portions 44 and 44 through the coupling portions 46 and 46. In addition, in the key top 41A, the pair of back abutting portions 47a and 47b and the front abutting portions 48a and 48b are integrally formed in a position separated in the front and back direction and the right and left direction.

Therefore, a dimension in the front and back direction (Y1-Y2 direction) may be reduced, so that it is possible to operate the input unit 33 by reliably pressing the input unit 33 by the pressing portion 52 even when any position of the operation surface 49 of the key top 41A is pressed.

Hereinafter, another embodiment of the present invention will be described.

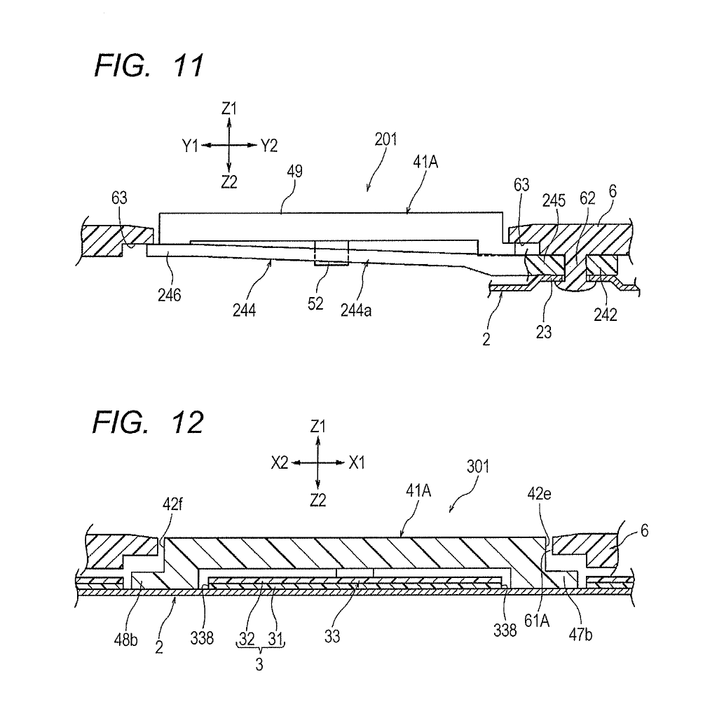

In FIG. 11, a key input device 201 according to a second embodiment of the present invention is shown. In the key input device 201 shown in FIG. 11, a shape of an arm portion 244 that supports the key top 41A and the shape of the arm portion 44 shown in FIG. 4B and the like are different from each other.

In the arm portion 244 of the key input device 201 according to the second embodiment, a connection portion 245 connected with a fixed portion 242 is positioned downward (Z2 side), a coupling portion 246 connected with the key top 41A is positioned upward (Z1 side) from the connection portion 245, and a deformation portion 244a extending obliquely upward toward the coupling portion 246 from the connecting portion 245 is provided.

Even in the second embodiment shown in FIG. 11, the key top Al may be positioned upward with respect to the fixed portion 242 when the pressing force does not act, and therefore a large descending stroke of the key top 41A may be ensured.

In FIG. 12, a key input device 301 according to a third embodiment of the present invention is shown. FIG. 12 shows the same cross-section as that in FIG. 6. In the key input device 301 shown in FIG. 12, an opening 338 that penetrates both the membrane switch laminated body 31 constituting the sheet laminated body 3 and the spring member holding sheet 32 is formed.

When the key top 41A is pressed, at least a part of the back abutting portions 47a and 47b and the front abutting portions 48a and 48b may penetrate the entire sheet laminated body 3, and descend up to a position corresponding to the substrate 2. Therefore, even when the key input device 301 is formed in a thin shape, a large descending stroke of the key top 41A may be ensured.

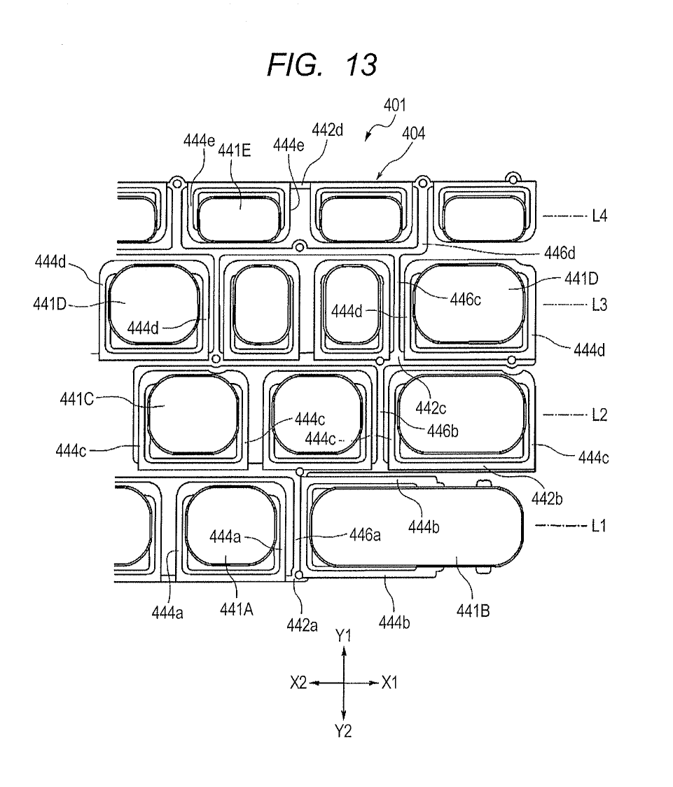

FIG. 13 shows a plan view of a part of the key input device 401 according to a fourth embodiment of the present invention.

In the key input device 401, a plurality of key tops 441A and 441B are arranged in parallel in the right and left direction (X1-X2 direction) in a row L1, a plurality of key tops 441C are arranged in parallel in the right and left direction in a row L2. A plurality of key tops 441D are arranged in parallel in the right and left direction in a row L3, and a plurality of key tops 441E are arranged in parallel in the right and left direction in a row L4.

In the row L1, a fixed portion 442a extending in the right and left direction (X1-X2 direction) is provided. In the row L2, a fixed portion 442b extending in the right and left direction is formed. In the row L3, a fixed portion 442c extending in the right and left direction is formed. In the row L4, a fixed portion 442d extending in the right and left direction is provided.

The fixed portion 442a of the first row L1 and the fixed portion 442b of the row L2 are connected in a coupling rib 446a extending in the front and back direction (Y1-Y2 direction), and the fixed portion 442b of the row L2 and the fixed portion 442c of the row L3 are connected in a coupling rib 446b extending in the front and back direction. In addition, the fixed portion 442c of the row L3 and the fixed portion 442d of the row L4 are connected in a coupling rib 446c and a coupling rib 446d.

As a result, all the fixed portions 442a, 442b, 442c, and 442d are connected with each other, and the key unit 404 which is wholly integrated is composed.

In the row L1, the key top 441A is supported by a pair of arm portions 444a and 444a protruding from the fixed portion 442a in the Y1 direction, and the key top 441B is supported by a pair of arm portions 444b and 444b protruding from the coupling rib 446a in the X1 direction.

In the row L2, the key top 441C is supported by a pair of arm portions 444c and 444c protruding from the fixed portion 442b in the Y1 direction, and in the row L3, the key top 441D is supported by a pair of arm portions 444d and 444d protruding from the fixed portion 442c in the Y1 direction.

In the row L4, the key top 441E is supported by a pair of arm portions 444e and 444e protruding from the fixed portion 442d in the Y1 direction.

It should be understood by those skilled in the art that various modifications, combinations, sub-combinations and alterations may occur depending on design requirements and other factors insofar as they are within the scope of the appended claims of the equivalents thereof.

What is claimed is:

1. A key input device having an input unit disposed on a substrate and a key top for pressing the input unit,
wherein a fixed portion fixed to the substrate, a pair of arm portions that are elastically deformable, and the key top supported at the arm portion are integrally formed, and
wherein the pair of arm portions extend along two side portions of the key top facing each other continuously with the fixed portion, a continuing coupling portion is provided in a direction crossing an extending direction of the arm portion on a tip of the arm portion, and at least a part of the coupling portion is connected to a side portion of a front side separated from the fixed portion of the key top.

2. The key input device according to claim 1, wherein a window portion is opened in a cover disposed above the substrate, and the key top is positioned inside the window portion, and
wherein an abutting portion protruding from both a rear side that is a side closer to the fixed portion and the front side is integrally formed in the key top, and the abutting portion abuts on an inner surface of the cover.

3. The key input device according to claim 2, wherein, the abutting portion that is divided into right and left direction is formed in each of the rear side and the front side of the key top.

4. The key input device according to claim 2, wherein at least a part of the coupling portion functions as the abutting portion.

5. The key input device according to claim 1, wherein a thickness dimension of the arm portion in a vertical direction that is a pressing direction of the key top is smaller than a width dimension thereof, and the arm portion is elastically deformable in both twisting direction and bending direction.

6. The key input device according to claim 5, wherein the coupling portion is also elastically deformable.

7. The key input device according to claim 1, wherein the coupling portion is positioned at an upper portion of a connection portion between the fixed portion and the arm portion, the upper portion being spaced apart from the substrate.

8. The key input device according to claim 1, wherein a sheet laminated body in which a plurality of flexible sheets are stacked is provided on the substrate, a spring member exerting an elastic force upward and a contact portion converted when the spring member is pressed toward the substrate are provided inside the sheet laminated body in the input unit, and the key top is biased upward by the spring member.

9. The key input device according to claim 8, wherein, an opening of bringing the key top close to the substrate when the key top is pressed is formed in the sheet laminated body.

10. The key input device according to claim 1, wherein the fixed portion is formed in a long shape, and plural groups of the arm portions are integrally formed with the fixed portion at an interval in the longitudinal direction.

11. The key input device according to claim 10, wherein a plurality of fixed portions are provided parallel to each other, a plurality of key tops supported by each of the fixed portions form a row, and a multiple number of the rows is provided.

12. The key input device according to claim 10, wherein a plurality of protrusions are provided on a cover disposed at an upper portion of the substrate, and the protrusion is inserted into a positioning hole opened in the fixed portion, so that the fixed portion is positioned.
